(19) United States
(12) Patent Application Publication
(10) Pub. No.: US 2026/0036946 A1
(43) Pub. Date: Feb. 5, 2026

(54) CONTROL METHOD AND CONTROL DEVICE WITH ANOMALY DETECTION

(71) Applicant: ABB Schweiz AG, Baden (CH)

(72) Inventors: Joachim Weissbacher, Bergheim (AT); Friedrich Gollner, Eggelsberg (AT); Hans-Peter Kraft, Russbach am Pass Gschütt (AT)

(21) Appl. No.: 19/273,564

(22) Filed: Jul. 18, 2025

(30) Foreign Application Priority Data
Aug. 1, 2024 (EP) 24192430.7

(51) Int. Cl. G05B 11/38; B25J 9/16

(52) U.S. Cl. CPC G05B 11/38; B25J 9/1666

(57) ABSTRACT

A method is provided for controlling a technical system by means of a Two Degree of Freedom controller, which allows for increased accuracy, higher robustness and better safety even in cases of changes of the technical system. The method comprises deriving an anomaly detection signal at an anomaly detection time point during control of the technical system. At least one control parameter parametrizing the Two Degree of Freedom controller is adapted depending on the anomaly detection signal and, from the anomaly detection time point onwards, the technical system is controlled by means of the Two Degree of Freedom controller parameterized by said at least one adapted control parameter.

### CROSS REFERENCE TO RELATED APPLICATIONS

The present application claims priority to European Patent Application No. 24192430.7 filed on Aug. 1, 2024, and titled “CONTROL METHOD AND CONTROL DEVICE WITH ANOMALY DETECTION”, which is hereby incorporated by reference in its entirety.

### TECHNICAL FIELD

The present disclosure pertains to a method for controlling an output of a technical system to a predefined setpoint by means of a Two Degree of Freedom controller having a feedforward part providing a first control output and a feedback part providing a second control output, the Two Degree of Freedom controller being parametrized by a multiple of control parameters, the feedback part computing said second control output from a control error representative of a deviation between the output of the technical system and the predefined setpoint, a sum-control-variable acting on the technical system to control the output to the setpoint being determined from the first control output and the second control output.

Further, the present disclosure pertains to a control system having a control unit on which a Two Degree of Freedom controller is implemented, for controlling an output of a technical system to a predefined setpoint.

### BACKGROUND

Various technical applications are known, where a technical system has to be controlled by means of a controller. Examples of technical systems requiring control are industrial robots with a robot arm whose movement needs to be controlled, long stator linear motors where the movements of shuttles need to be controlled, or engine testbeds, where torques produced by a dynamometer or by a device under test (for example, an internal combustion engine) demand control, etc. Typically, the goal set out in a control problem is to control an output of a technical system to a predefined reference value (for example a demanded torque, a demanded speed/position profile, a demanded pressure, etc.).

In cases as the ones referred to above, a broad range of aspects has to be taken into account when designing and/or parameterizing a controller, including static and/or dynamic behavior of a system to be controlled, potential modifications of the system, disturbances acting on the system, etc. Only correctly tuned controllers are able to adequately and satisfyingly control a technical system over its entire operating range, especially with respect to a resulting dynamical or steady-state control error, or with respect to the dynamics of a resulting closed control loop, to stability, controllability, or another control metric etc. Moreover, in practice, many systems behave nonlinearly and vary with time, rendering controller design and/or parameterization a difficult task. Therefore, in a first activity, often only a structure of a controller (controller structure) is provided when designing a controller for a given technical system, which structure is then, in a second activity, parameterized (assigning values to the controller parameters used in the structure), by tuning said controller parameters in order to achieve a desired (closed loop) control behavior. Tuning parameter values in said second activity allows to react to priorly unknown nonlinearities and variations of a system. However, the tuning of controller parameters frequently proves to be complex and difficult, even in cases where simple controller structures are used, for example PI-controllers or PID-controllers or sliding-mode controllers, due to said nonlinearities of a system, or due to said time variant behavior, but also due to disturbances etc. Therefore, trained and experienced experts are typically required to successfully parameterize a controller.

Said aspects are especially true for Two Degree of Freedom (2DoF) controllers, which are known from, for example CN 114779648 A. 2DoF-controllers typically comprise a feedforward part providing a first control output and a feedback part providing a second control output, the feedback part computing said second control output from a control error representative of a deviation between an output of a technical system to be controlled and a predefined set-point. 2DoF-controllers are well suited for many applications, due to good reference tracking performance and robust disturbance rejection. In cases of appropriate parametrization of especially the feed-forward path, the feed-forward path carries out most of the control work, leaving only little work to the feedback part.

However, a frequently encountered problem with 2DoF-controllers results from the fact that this type of controller typically uses an inverse of the system to be controlled in the feedforward part, inverting a desired set point into a control signal, in other words, into said first control output, making sure that the set point is achieved with only little contribution from the feedback part. In case the system to be controlled changes, for example due to disturbances acting on the system, or due to modifications of the system caused by wear or aging, or due to the impact of nonlinearities, an inverse model used in a feed forward path may deviate from an actual, in other words, from a correct, inverse of a system at a given point in time, leading to wrong control actions by the feed forward path, requiring the feedback part to do more work than planned and expected. This can deteriorate the performance of a technical system controlled by a 2DoF-controller, potentially leading to reduced control accuracy, reduced robustness, and even endanger a system to be controlled.

### BRIEF DESCRIPTION

It is therefore an object of the present disclosure to provide a method for controlling a technical system by means of a Two Degree of Freedom controller, which method allows for increased accuracy, higher robustness, and better safety even in cases of changes of the system to be controlled.

This object, for the method mentioned at the outset, is achieved in that, at an anomaly detection time point during control of the output of the technical system, an anomaly detection signal is derived from the control error present at said anomaly detection time point, in that at least one control parameter of the multiple of control parameters parametrizing the Two Degree of Freedom controller is adapted depending on the anomaly detection signal and in that, from the anomaly detection time point onwards, the output of the technical system is controlled by means of the Two Degree of Freedom controller parameterized by said at least one adapted control parameter. In some embodiments, as discussed above, the feedforward path employs an inverse model of the technical system to compute the first control output from the setpoint. However, the present disclosure allows for flexibility in this regard, namely, with regards to where said inverse model of the technical system is used, such that the first control output may also be computed outside of the Two Degree of Freedom controller, in some embodiments by means of an inverse model of the technical system, and may be fed to the Two Degree of Freedom controller as an input and may be simply be passed, namely, fed forward, on in the feedforward path. In some embodiments, sum-control-variable is computed from the first control output and the second control output by simply summing the first control output and the second control output. However, also in this regard, different approaches may be employed, such as scaling the first control output and/or the second control output with appropriately selected scaling weights before summing them or by filtering the first control output and the second control output before computing the sum-control-variable.

The core idea and/or core insight of the present disclosure is that in case a two-degree-of-freedom controller is used to control a technical system, a control error between the output of the technical system and the predefined setpoint is indicative of a deviation between an assumed model behavior and a real behavior of the real technical system. In case of a (classical) controller that does not comprise a feed-forward path, or at least not an initially correctly parameterized feed-forward path, such a conclusion cannot be drawn. In case of a classical controller, a control error is even necessary to allow for any control action to be generated. Hence, in such a case, a control error does not provide any insight regarding the presence of any sort of anomaly.

Due to said dependency between control errors and anomalies, in case of a two-degree-of-freedom controller, information transported by a control error can be used to react to changes in a technical system to be controlled and hence improve a controller. In particular, a controller and/or a controller's parameters may be adapted, in case a deviation due to an anomaly is detected by analyzing a control error.

In some embodiments of the present disclosure, the anomaly detection signal may be derived from the control error as an, in some embodiments scaled, absolute value of the control error or as a, in some embodiments scaled, squared value of the control error or as an, in some embodiments scaled, L-norm of the control error. Depending on the specifics of a given use case, an appropriate norm may thus be used to overcome and optimally deal with potential obstacles present in said specific use case, such as signal noise or dynamic disturbances or systematic disturbances.

To prepare the anomaly detection signal for further signal processing, the anomaly detection signal may also be filtered by means of a predefined filter, in some embodiments a low-pass filter or a band-pass filter or a high-pass filter or a notch filter, before being used to adapt the at least one control parameter of the multiple of control parameters.

To adapt said control parameters in reaction to an identified anomaly, a, in some embodiments static, linear or non-linear function may be provided describing a dependency between the anomaly detection signal and the at least one control parameter of the multiple of control parameters to be adapted. Based on such a linear or non-linear function, said anomaly detection signal may be fed into said linear or non-linear function, computing an adapted control parameter value to adapt and thus update and thus improve the controller. The dependency between anomaly detection signal and control parameter may also be implemented in the form of a dynamical function and thus a dynamical system, for example a filter etc., as mentioned above. Moreover, the dependency between anomaly detection signal and control parameter may also comprise specific nonlinearities to fit the needs of a given use case, particularly, according to some embodiments, a dead-zone in order to overcome, for example signal noise, where no or only a reduced adaptation is carried out in case the anomaly detection signal lays inside the dead-zone.

The present disclosure also provides for flexibility with regards to how the Two Degree of Freedom controller may be modified based on the anomaly detection signal. Specifically, in some embodiments, a limitation element parameterized by at least one limitation parameter may be provided in the Two Degree of Freedom controller to limit the first control output and/or to limit the second control output and/or to limit the sum-control-variable, the at least one limitation parameter being one of the multiple of control parameters to parametrize the Two Degree of Freedom controller, and the at least one limitation parameter being adapted depending on the anomaly detection signal. Limiting the output of a controller is particularly helpful in cases of anomalies whose root cause is not immediately apparent. In such a case, it is oftentimes reasonable to control more carefully, thus to further limit and reduce the available and hence applied control energy and/or control action, in order to avoid damages. Particularly, according to some embodiments, the feedback part may solely consist of a proportional controller, having no integral part. Omitting an integral part avoids potential problems with the well-known phenomenon of controller wind-up, especially in case a limitation parameter is modified, especially reduced.

In the embodiments laid out above, the adaptation of the at least one control parameter of the multiple of control parameters may only be carried out in case an absolute value of the anomaly detection signal surpasses a predefined anomaly-threshold, making sure that an adaption, such as a reduction of an absolute value of the at least one control parameter of the multiple of control parameters of the two-degree-of-freedom controller, is only carried out in cases of significant deviations and anomalies, hence avoiding constant and thus useless adaptions due to, for example, signal noise.

Moreover, not only with regards to implementation specifics, but also with regards to the systems that the method is applied to, the present disclosure allows for flexibility. Hence, a planar motor may be controlled as the technical system or a long stator linear motor may be controlled as the technical system or an industrial robot may be controlled as the technical system or a tool machine may be controlled as the technical system. In case an industrial robot is controlled as the technical system, a detected anomaly may particularly be indicative of a collision of the robot with a mechanical object.

Besides the method outlined above, the object mentioned at the outset is achieved by a control system having a control unit on which a Two Degree of Freedom controller is implemented for controlling an output of a technical system to a predefined setpoint, the control unit being capable of carrying out the method according to the present disclosure explained above.

### BRIEF DESCRIPTION OF DRAWINGS

The present disclosure is described below in greater detail with reference to FIGS. 1 to 7, which show schematic and non-limiting advantageous embodiments of the present disclosure by way of example.

FIG. 1 shows the known structure of a 2DoF controller.

FIG. 2 shows a measured 2DoF control signal.

FIGS. 3a and 3b show control error signals, an anomaly threshold and an anomaly detection signal obtainable with the present disclosure.

FIG. 4 shows a first implementation of a 2DoF controller.

FIG. 5 shows a second implementation of a 2DoF controller.

FIG. 6 shows a first implementation of the present disclosure based on an adapted limitation value.

FIG. 7 shows a second implementation of the present disclosure based on adapted limitation values.

### DETAILED DESCRIPTION

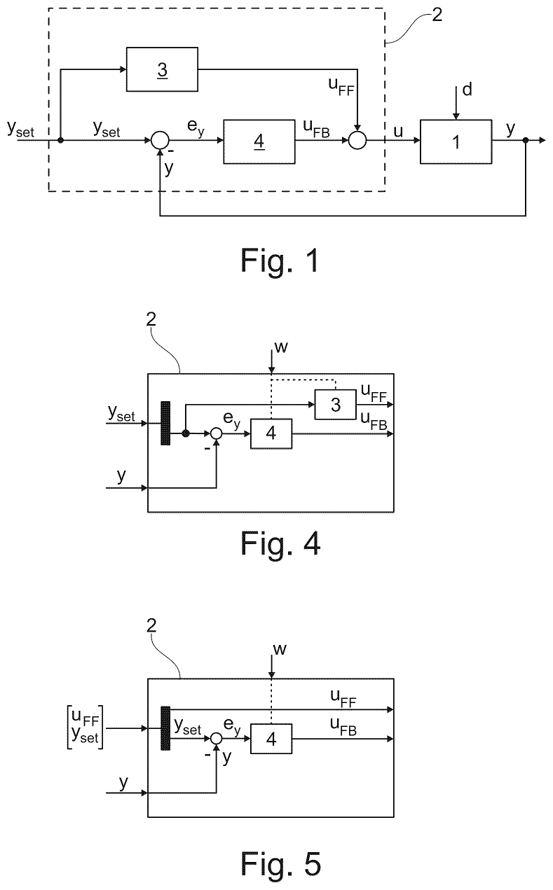

In FIG. 1, the general and well-known structure of a Two Degree of Freedom (“2DoF”, 2DoF and “Two Degree of Freedom” are used synonymously hereafter) controller 2 for controlling a technical system 1 is shown. The Two Degree of Freedom controller 2 comprises a feedforward part 3 and a feedback part 4. As it is often impossible to achieve good setpoint tracking and fast disturbance rejection at the same time with ordinary feedback controllers having only one degree of freedom (for example classical P-, PI-, PID-controllers etc.), a Two Degree of Freedom (2DoF) controller 2 with two degrees of freedom as shown in FIG. 1 can be used. The technical system 1 is, for example, a mechanical system, driven by a sum-control-variable u, providing an actual position as an output y, which is, in some embodiments, measured by an encoder, for example. More specifically, a planar motor PM or a long stator linear motor LLM or an industrial robot or a delta robot or a tool machine may be controlled as a technical system 1. Depending on the specifics of the technical system 1, said sum-control-variable u may be fed to an actuator, for example an amplifier or a power amplifier or a frequency converter or a servo drive etc., which actuator eventually acts on the technical system 1 in accordance with the sum-control-variable u. A skilled person familiar with a technical system 1 to be controlled of course knows which actuator best fits a specific use case. However, a sum-control-variable u may also act directly on a technical system 1 to be controlled.

The aim of the Two Degree of Freedom controller shown is to control an output y of the shown technical system 1 to a predefined setpoint yₛₑₜ. As is well-known from control engineering, said feedforward part 3 and said feedback part 4 typically comprise parameters, such as a proportional gain kₚ in a proportional path or an integral gain ki of an integral path or gains of an Anti-Windup scheme, such as of an Anti-Windup scheme in the sense of Hanus (cf. Hanus, Raymond, Michel Kinnaert, and J-L. Henrotte. “Conditioning technique, a general anti-windup and bumpless transfer method.” Automatica 23.6 (1987): 729-739.) in the feedback part 4, or a feed-forward gain in the feedforward part 3, or a limitation value uₘₐₓ to limit at least one, potentially also more of the control signals computed in the controller 2.

As it is typically the case in control engineering practice, the feedback part 4 is designed to compute said second control output u_{FB} from a control error e_{y} representative of a deviation between the output y of the technical system 1 and the predefined setpoint yₛₑₜ, and the Two Degree of Freedom controller 2 is designed to eventually determine a sum-control-variable u acting on the technical system 1 to control the output y to the setpoint yₛₑₜ from the first control output u_{FF} and the second control output u_{FB}. As can be seen from FIG. 1, the sum-control-variable u is computed from the first control output u_{FF} and the second control output u_{FB} by summing the first control output u_{FF} and the second control output u_{FB}. In the case of a mechanical system as technical system 1, the sum-control-variable u may correspond to a torque or to a force.

The controller design is usually carried out by means of a (mathematical) model of the technical system 1 that comprises also certain state variables xᵢ(i representing an index, as is well-known in control engineering). The model of the technical system 1 maps the input (control variable u) onto the output y. There can of course also be more than just one output variable y. State variables xᵢ are typically stacked into state-vector x with dimension nd≥1, n describing the dimension of the system 1. The 2DoF controller 2 oftentimes additionally utilizes certain state variables xᵢ of the technical system 1, such as an engine speed n in case of an engine as technical system 1 to be controlled. State variables xᵢ can be measured by using appropriate sensors or encoders, or can be calculated by using a simulation model, or can be estimated with an observer for the state variable xᵢ from other known (for example measured) variables of the technical system 1, such as from an output y.

As is also well-known from the prior art, the feedforward part 3 may encompass an inverse of the technical system 1 to be controlled, namely an inverse of the model of the technical system 1. By means of an inverse model of the technical system 1, it becomes possible to compute a control variable u_{FF} from a desired setpoint yₛₑₜ in the feedforward part 3, which, in an ideal scenario without disturbances d and deviations of the real behavior of the system 1 from an assumed behavior, already alone allows to solve the control objective, namely, to control the output y to the setpoint yₛₑₜ. However, the dynamics of a technical system 1 is oftentimes nonlinear and time variant. Thus, it is frequently difficult to determine the inverse of a nonlinear technical system model, making the implementation of the feedforward part 3 of a 2DoF controller 2 a challenging task.

To account for these considerations, in the case shown in FIG. 1, it is assumed that a disturbance d acts on the technical system 1, which must be compensated by the controller, and which may lead to a deviation of the real behavior of the technical system 1 from an assumed behavior, which assumed behavior may be reflected in a mathematical model of the technical system 1. In an ideal case without disturbances (d=0), in which the model parameters are identical to the real system parameters, u=u_{FF} already by itself forms a control signal that leads to y=yₛₑₜ. In this ideal case (feedforward part 3 is the inverse of the real, acting system), the feedback part 4 has nothing to do (open-loop operation).

The feedback part 4, may solely consist of a proportional controller kₚ*e_{y}, having no integral part, which allows to avoid issues that could potentially be connected the phenomenon of windup. As will be explained later, this aspect is particularly advantageous within the scope of present disclosure, as it avoids potential issues related to the well-known phenomenon of wind-up, see above. However, also other control architectures are conceivable for the feedback part 4, such as PI-controllers or PID-controllers or sliding-mode controllers etc.

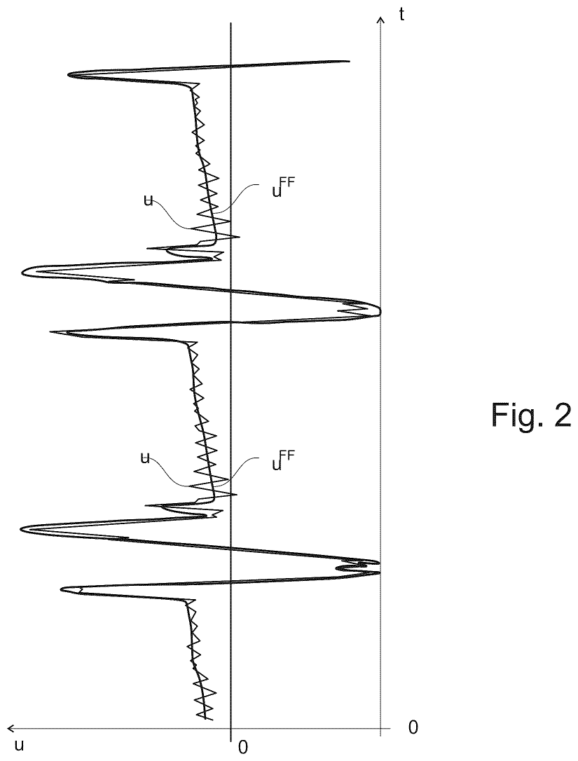

FIG. 2 shows a measured 2DoF control signal, namely a sum-control-variable u, in the case of a mechanical system as technical system 1 to be controlled, specifically an axis of an industrial robot. In case of said robot, a set torque and a set position for the robot arm are calculated centrally on a central computing unit, which may be implemented in the form of a PLC, and are transferred via a field bus system, for example Ethernet or Ethercat or Ethernet Powerlink or Profibus etc., to specific control units on which control structures as the one shown in FIG. 1 are implemented to carry out the control for a specific arm. In the scope of the present disclosure, a control unit running a 2DoF controller 2 as shown in FIG. 1 may be implemented in the form of FPGA, a microcontroller etc.

As can be seen from FIG. 2, in case the controller parameters are selected appropriately, the first control output u_{FF} generated by the feedforward part 3 and the sum-control-variable u eventually output by the controller 2 are highly alike. As mentioned previously, the deviation between the sum-control-variable u and the first control output u_{FF} generated by the feedforward part 3 can be interpreted as a proportion of the control signal that the feedback part 4 still needs to apply in order to solve the control objective with sufficient accuracy. Ideally, the deviation is around zero and essentially consists of oscillations due to the control behavior or due to model deviations or due to disturbances d that cannot be taken into account when setting up a model. In an ideal scenario, without disturbances d and a perfect model of the technical system 1, thus a perfect inverse model used in the feedforward part 3, already the feedback part 3 alone would solve the control task. Hence, the deviation between the first control output u_{FF} and the sum-control-variable u, which corresponds to the control error e_{y}, can be interpreted as a measure of model inaccuracies and/or disturbances. Inaccuracies, disturbances and other effects that lead to deviations from an ideal model behavior are subsumed hereafter as “anomalies”. In case the inaccuracies become too large, the controller 2 may not function properly anymore. Thus, the present disclosure provides for a method that allows to react to said anomalies leading to modifications of the technical system 1 and hence to said inaccuracies.

To that end, within the scope of the present disclosure, it is provided to, at an anomaly detection time point t_{w} during control of the output y of the technical system 1, derive an anomaly detection signal w from the control error e_{y} present at said anomaly detection time point t_{w}, to adapt at least one control parameter of the multiple of control parameters kₚ, kᵢ, uₘₐₓ parametrizing the Two Degree of Freedom controller 2 depending on the anomaly detection signal w and to, from the anomaly detection time point t_{w} onwards, control the output y of the technical system 1 is by means of the Two Degree of Freedom controller 2 parameterized by said at least one adapted control parameter kₚ, kᵢ, uₘₐₓ. The present disclosure thus allows for a relatively simple way of detecting an anomaly and reacting to it accordingly (actively or proactively).

In course of the present disclosure, it was found that in case a two-degree-of-freedom controller is used, the control error is indicative of a deviation between the assumed model behavior and the behavior of the real technical system. In case of a (classical) controller that does not comprise a feed-forward path, such a conclusion cannot be drawn. In case of a classical controller, a control error is necessary, in order to allow for any control input to be generated. Hence, in such a case, a control error does not provide any insight regarding the presence of any kind of anomaly.

As it is typically the case in modern control engineering, the Two Degree of Freedom controller 2 may be implemented as a discrete-time Two Degree of Freedom controller 2, the control outputs u_{FB}, u_{FF} being ongoingly computed at equidistantly spaced discrete control time points tₖ, typically spaced by a constant, predefined sampling time Td of, for example, T_{d}=10 μs or T_{d}=100 μs or T_{d}=1 ms or T_{d}=10 ms etc., the anomaly detection signal w being ongoingly computed at equidistantly spaced discrete detection time points t_{w}. Beneficially, the discrete control time points tₖ and the detection time points t_{w} may coincide.

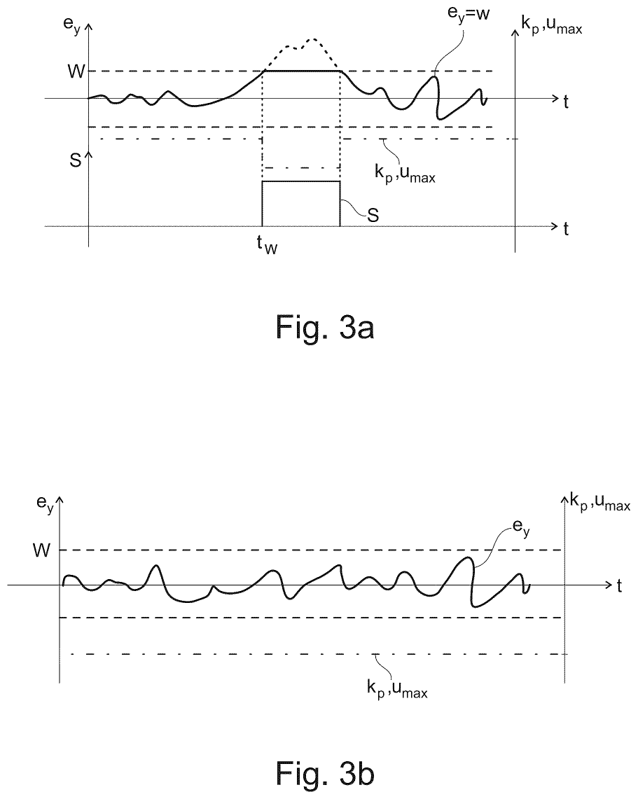

To allow for a more detailed discussion of the present disclosure, FIGS. 3a and 3b each show control error signal e_{y}, an anomaly threshold W and an anomaly detection signal w obtainable by means of the present disclosure. An anomaly threshold W may in particular be provided to carry out the adaptation of the at least one control parameter of the multiple of control parameters kₚ, kᵢ, uₘₐₓ only in case the absolute value of the control error e_{y} surpasses a predefined anomaly-threshold W. As can be seen in FIG. 3a, the anomaly detection signal w is set equal to the control error e_{y}. However, also other design options for deriving the anomaly detection signal w exist, which will be explained later. At the anomaly detection time point t_{w}, the detection signal w exceeds said predefined anomaly-threshold W, which is additionally emphasized by the status signal s.

As can further be seen in FIG. 3a, a control parameter to be adapted, in FIG. 3a indicated by parameters kₚ and uₘₐₓ, is reduced as long as the anomaly-threshold W is exceeded. Reducing a control parameter is particularly useful in some embodiments. An important reason therefor is that an anomaly indicates some sort of deviation from an assumed model behavior. Hence, in order to reduce the risk of problems that might result from such deviations, such as a potential loss of stability, reducing control parameters allows to increase, for instance a stability margin, and thus make the operation safer again. Reducing the control parameters allows to refuse the controller as a whole.

Speaking again in general terms, to detect an anomaly, a non-linear function may be provided to arrive at the anomaly detection signal w:

$$w = f ( {y}_{set} , {\dot{y}}_{set} , {\ddot{y}}_{set} , {u}_{FF} , {\dot{u}}_{FF} , {\ddot{u}}_{FF} , y , \dot{y} , \ddot{y} , … )$$

In the simplest case, the deviation of the actual output y from the target setpoint yset can be used directly for this purpose:

$$w := e = {y}_{set} - y$$

If the signal quality allows it, higher derivatives of the variables mentioned can also be included:

$$w = {k}_{1} ( {y}_{set} - y ) + {k}_{2} \frac{d}{dt} ( {y}_{set} - y ) + {k}_{3} \frac{{d}^{2}}{{dt}^{2}} ( {y}_{set} - y ) + …$$

As indicated by the formula above, a control error e_{y}=yset−y and its derivations may of course also be scaled by appropriate scaling weights. Hence, the anomaly detection signal w may be derived from the control error e_{y} as an, in some embodiments scaled, absolute value |e| of the control error e_{y} or as a, in some embodiments scaled, squared value e² of the control error ey or as an, in some embodiments scaled, L-norm L(e) of the control error ey, hence allowing for great flexibility, especially when it comes to fine tune the present disclosure to a specific practical use case.

With regards to the dependency between the anomaly value and the at least one control parameter, a linear or non-linear function is provided to describe a dependency between the anomaly detection signal w and the at least one control parameter of the multiple of control parameters kp, ki, umax. However, different approaches are conceivable in this regard. For instance, the sum-control-variable u may also be frozen to a pre-defined value in case said anomaly-threshold W is exceeded, hence effectively deactivating the 2DoF controller 2.

In the cases referred to above, the differentiating behavior can increase sensitivity and lead to a faster reaction in the status formation described below. The f( . . . ) function can also have an additional filtering effect in the case of noisy signals. The specified deviation can also be used to create a status signal s, as already indicated in FIG. 3a:

$$s = \{ \begin{matrix}1 , & \vert e \vert > W \\ 0 , & otherwise\end{matrix}$$

It is also conceivable to make the threshold W asymmetrical (using two values (W1, W2)) or variable in time (W1(t), W2(t)), in order to be able to adapt the detection even more individually.

As mentioned at the outset, a planar motor PM or a long stator linear motor LLM or an industrial robot, especially in the form of a delta robot, may be controlled as the technical system 1. The application may be used wherever electrically driven axes come into contact with other machine parts, for example in case of packaging machines, robotics, planar motors (PM), long stator linear motors (LLMs), etc. In case an industrial robot is controlled as the technical system 1, a detected anomaly may in particular be indicative of a collision of the robot with a mechanical object. By applying the teachings of the present disclosure, many types of anomalies can be detected, even unexpected unstable behavior, resulting from changes in the plant causing instability. Regardless of whether this is a disturbance from outside or a parameter variation of the controlled system (change in the mechanics). Specifically, collisions can be detected at an early stage. In the event of a collision, the control error ey and hence the anomaly detection signal w will increase abruptly. This change of state will be detected and the control action will be restricted in accordance with the parameterization.

Specifically, in the case of an industrial robot, by means of the present disclosure, a detection of the loss of an arm in a tripod can be detected, or an incorrect parameterization may be detected as an anomaly, or an incorrectly parameterized tool may be detected, or mechanical changes over time (friction, bearing damage, looseness, . . . ) may be detected, but also changes in a drivetrain (for example belt wear, blockage, slipping clutches, etc.) may be detected, indicating when model parameters should be adjusted (running-in behavior of the mechanics, temperature influence, process change, etc.).

Depending on the operating mode (centralized, decentralized), also other versions of a 2 DoF controller 2 are conceivable, particularly as shown in FIGS. 4 and 5. Specifically, as shown in FIG. 4, in the case of decentralized control (single-axis operation), the feedforward control u_{FF} is determined from the setpoint yₛₑₜ, in the controller 2 itself. However, in case of centralized control (as it is typical when operating a group of axis, “axis group”), the feedforward control may also be calculated centrally, in other words, outside of the Two Degree of Freedom controller, hence a tuple [yₛₑₜ, u_{FF}] being fed to the respective drive, as depicted in FIG. 5. Therefore, the first control output u_{FF} may be computed outside of the Two Degree of Freedom controller 2, in some embodiments by means of an inverse model of the technical system 1, fed to the Two Degree of Freedom controller 2 as an input and processed forward by the feedforward path 3, or the feedforward path 3 may use an inverse model of the technical system 1 to compute said first control output u_{FF} from the setpoint yset.

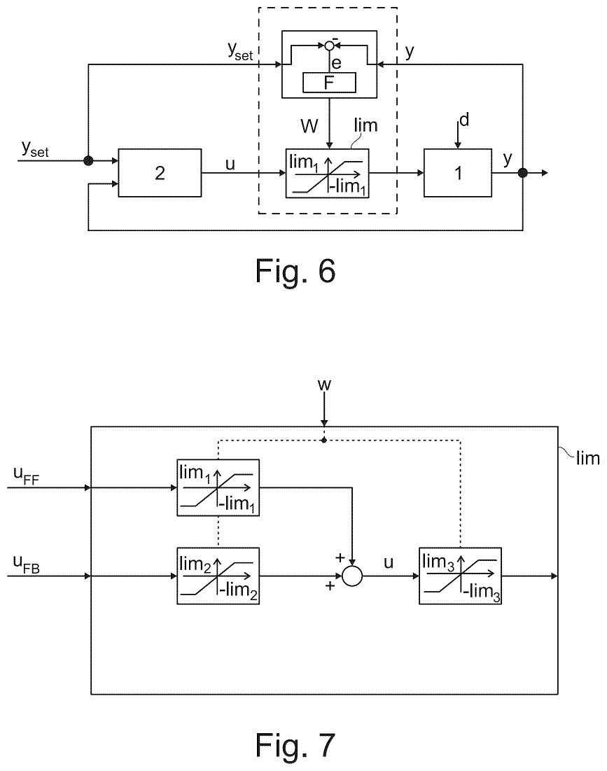

FIG. 6 further shows a possible implementation of the present disclosure based on an adapted limitation value. The limitation can be carried out in the feedforward branch, in the feedback branch, but can also act on entire manipulated variable, namely, the sum-control-variable u. However, also other options to implement a limitation are conceivable (symmetrical, asymmetrical, time-dependent, process-dependent, . . . ).

Moreover, as depicted in FIG. 6 as well, the anomaly detection signal w may, in some embodiments, be filtered by means of a predefined filter F, in some embodiments a low-pass filter or a band-pass filter or a high-pass filter or a notch filter, before being used to adapt the at least one control parameter of the multiple of control parameters kₚ, kᵢ, uₘₐₓ.

As also shown in FIG. 6, after the filter F, the anomaly value is connected to a limitation element lim. To implement the present disclosure, a limitation element lim as the one shown in FIG. 6 parameterized by at least one limitation parameter lim1 may be provided in the Two Degree of Freedom controller 2 to limit the first control output u_{FF} and/or to limit the second control output u_{FB} and/or to limit the sum-control-variable u, such that the at least one limitation parameter uₗᵢₘ may be considered as one of the by a multiple of control parameters kₚ, kᵢ, uₘₐₓ to parametrize the Two Degree of Freedom controller 2, and the at least one limitation parameter uₗᵢₘ is adapted depending on the anomaly detection signal w.

A second implementation of the present disclosure based on adapted limitation values is presented in FIG. 7. In both cases shown in FIGS. 6 and 7, a conceivable approach to implement the present disclosure is to provide for a first, regular value of said limitation values lim1, lim2, lim3, in case no anomaly is detected, and for a second set of values, whose absolute value is smaller, for the case that an anomaly is detected and that a reduction is required.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for controlling an output of a technical system to a predefined setpoint by a Two Degree of Freedom controller, wherein the Two Degree of Freedom Controller comprises:
a feedforward part that provides a first control output; and
a feedback part that provides a second control output, wherein the Two Degree of Freedom controller is parametrized by a plurality of control parameters, and
wherein the method comprises:
computing, by the feedback part, the second control output from a control error representative of a deviation between the output of the technical system and the predefined setpoint;
determining, from the first control output and the second control output, a sum-control-variable acting on the technical system to control the output to the setpoint;
deriving, at an anomaly detection time point during control of the output of the technical system, an anomaly detection signal from the control error present at the anomaly detection time point;
adapting at least one control parameter of the plurality of control parameters parametrizing the Two Degree of Freedom controller, based on the anomaly detection signal; and
controlling, from the anomaly detection time point onwards, the output of the technical system by the Two Degree of Freedom controller parameterized by the at least one control parameter.

2. The method according to claim 1, wherein the feedforward path uses an inverse model of the technical system to compute the first control output from the setpoint.

3. The method according to claim 1, wherein:
the first control output is computed outside of the Two Degree of Freedom controller,
fed to the Two Degree of Freedom controller as an input, and
processed forward by the feedforward path.

4. The method according to claim 1, further comprising computing the sum-control-variable from the first control output and the second control output by summing the first control output and the second control output.

5. The method according to claim 1, wherein:
the anomaly detection signal is derived from the control error as an absolute value of the control error, or
the anomaly detection signal is derived from the control error as a squared value of the control error, or
the anomaly detection signal is derived from the control error as an L-norm of the control error.

6. The method according to claim 1, further comprising filtering, by a predefined filter, the anomaly detection signal before using the anomaly detection signal to adapt the at least one control parameter of the plurality of control parameters.

7. The method according to claim 1, wherein a linear or non-linear function is provided to describe a dependency between the anomaly detection signal and the at least one control parameter of the plurality of control parameters.

8. The method according to claim 1, wherein:
a limitation element parameterized by at least one limitation parameter is provided in the Two Degree of Freedom controller to limit the first control output and/or to limit the second control output and/or to limit the sum-control-variable,
the at least one limitation parameter is one of the plurality of control parameters that parametrize the Two Degree of Freedom controller, and
the method further comprises adapting the at least one limitation parameter based on the anomaly detection signal.

9. The method according to claim 1, wherein:
the Two Degree of Freedom controller is implemented as a discrete-time Two Degree of Freedom controller,
the control outputs are ongoingly computed at equidistantly spaced discrete control time points, and
the anomaly detection signal is ongoingly computed at equidistantly spaced discrete detection time points.

10. The method according to claim 9, wherein the discrete control time points and the detection time points coincide.

11. The method according to claim 1, wherein the adaptation of the at least one control parameter of the plurality of control parameters is carried out if an absolute value of the anomaly detection signal surpasses a predefined anomaly-threshold.

12. The method according to claim 11, wherein an absolute value of the at least one control parameter of the plurality of control parameters is reduced in order to adapt the at least one control parameter of the plurality of control parameters if the anomaly detection signal surpasses the predefined anomaly-threshold.

13. The method according to claim 1, wherein:
a planar motor is controlled as the technical system, or
a long stator linear motor is controlled as the technical system, or
an industrial robot is controlled as the technical system, or
a tool machine is controlled as the technical system.

14. The method according to claim 1, wherein the feedback part solely consists of a proportional controller, having no integral part.

15. A control system having a control unit on which a Two Degree of Freedom controller is implemented for controlling an output of a technical system to a predefined setpoint, the Two Degree of Freedom controller comprising:
a feedforward part that provides a first control output; and
a feedback part that provides a second control output, wherein:
the Two Degree of Freedom controller is parametrized by a plurality of control parameters,
the feedback part is configured to;
compute the second control output from a control error representative of a deviation between the output of the technical system and the predefined setpoint,
the Two Degree of Freedom controller is configured to:
determine a sum-control-variable acting on the technical system to control the output to the setpoint from the first control output and the second control output, and
the control unit is configured to:
at an anomaly detection time point during control of the output of the technical system, derive an anomaly detection signal from the control error present at the anomaly detection time point;
adapt at least one control parameter of the plurality of control parameters parametrizing the Two Degree of Freedom controller based on the anomaly detection signal; and
from the anomaly detection time point onwards, control the output of the technical system by means of the Two Degree of Freedom controller parameterized by the at least one adapted control parameter.

16. The method according to claim 3, wherein the first control output is computed by an inverse model of the technical system.

17. The method according to claim 5, wherein:
the absolute value of the control error is scaled, or
the squared value of the control error is scaled, or
the L-norm of the control error is scaled.

18. The method according to claim 6, wherein the predefined filter is selected from a group consisting of:
a low-pass filter,
a band-pass filter,
a high-pass filter, and
a notch filter.

19. The method according to claim 13, wherein the anomaly detection signal is indicative of a collision of the robot with a static mechanical object.

20. The control system according to claim 15, wherein the feedforward path uses an inverse model of the technical system to compute the first control output from the setpoint.
